(19) United States
(12) Patent Application Publication
(10) Pub. No.: US 2007/0230714 A1
(43) Pub. Date: Oct. 4, 2007

(54) Time-delay hearing instrument system and method

(76) Inventor: Stephen W. Armstrong, Burlington (CA)

Correspondence Address: Joseph M. Sauer, Esq.;Jones Day, North Point, 901 Lakeside Avenue, Cleveland, OH, 44114, US

(21) Appl. No.: 11/396,805

(22) Filed: Apr. 3, 2006

(51) Int. Cl. H04R 1/10; H04B 5/00; H04R 5/02

(52) U.S. Cl. 381/74; 381/309; 381/79

(57) ABSTRACT

A binaural hearing instrument system includes a first hearing instrument configured to transmit sound signals into a first ear of a hearing instrument user, and a second hearing instrument configured to transmit sound signals into a second ear of the hearing instrument user. The first and second hearing instruments include wireless communications circuitry configured to transmit signals, including sound signals, over an air interface between the first and second hearing instruments. Binaural processing circuitry is configured to apply a time delay to a sound signal received by the first hearing instrument to generate a delayed sound signal. The first hearing instrument is configured to transmit the received sound signal into the first ear of the hearing instrument user, and the second hearing instrument is configured to transmit the delayed sound signal into the second ear of the hearing instrument user.

### FIELD

The technology described in this patent document relates generally to the field of hearing instruments. More particularly, the technology described herein relates to binaural hearing instrument systems.

### BACKGROUND

Binaural hearing systems exist that transmit sound into both ears. However, an effect of transmitting the same sound into both ears at the same time is that the sound is perceived by the user as originating from inside the head or coming from straight ahead. For some applications this can be disorienting. For example, a binaural hearing instrument may transmit the sound coming from a telephone speaker to both ears at the same time. This effect is disorienting to the user because the user expects the sound to come from the ear that the telephone speaker is adjacent to.

One solution to this problem is to turn off one of the hearing instruments and only receive sound from a single ear. However, users that need binaural hearing instrument systems may have difficulty hearing without the additional amplification provided by the binaural capabilities of the system.

### BRIEF DESCRIPTION OF THE DRAWINGS

FIG. 1 is a schematic view of a first example time-delay binaural hearing instrument system.

FIG. 2 is a flow chart of the operation of the first example time-delay binaural hearing instrument system.

FIG. 3 is a flow chart of the operation of a second example time-delay binaural hearing instrument system.

FIG. 4 is a flow chart of the operation of a third example time-delay binaural hearing instrument system.

FIG. 5 is a diagram of a telephone application for an example time-delay binaural hearing instrument system having a microphone.

FIG. 6 is a diagram of a telephone application for an example time-delay binaural hearing instrument system having a telecoil.

FIG. 7 is a diagram of an input jack application for an example time-delay binaural hearing instrument system having an input jack that receives an electronic sound signal.

FIG. 8 depicts an example time-delay hearing instrument system on a user in an automobile.

FIG. 9 depicts an example time-delay hearing instrument system used as part of a video or teleconferencing application.

FIG. 10 is a flow chart of the operation of an example binaural hearing instrument system applying a time delay in both ears.

FIG. 11 is a diagram of an example time-delay binaural hearing instrument system applying a time delay to both ears.

FIG. 12 is a block diagram of an example hearing instrument showing a more-detailed example of communications circuitry.

FIG. 13 is a functional diagram of an example baseband processor for a hearing instrument.

### DETAILED DESCRIPTION

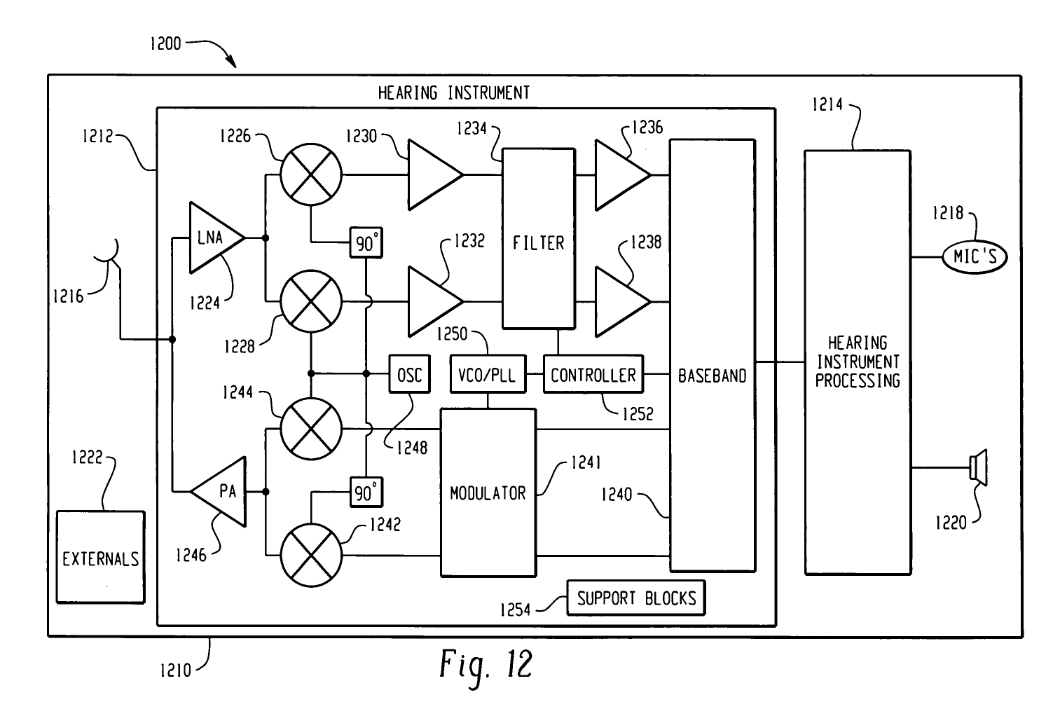

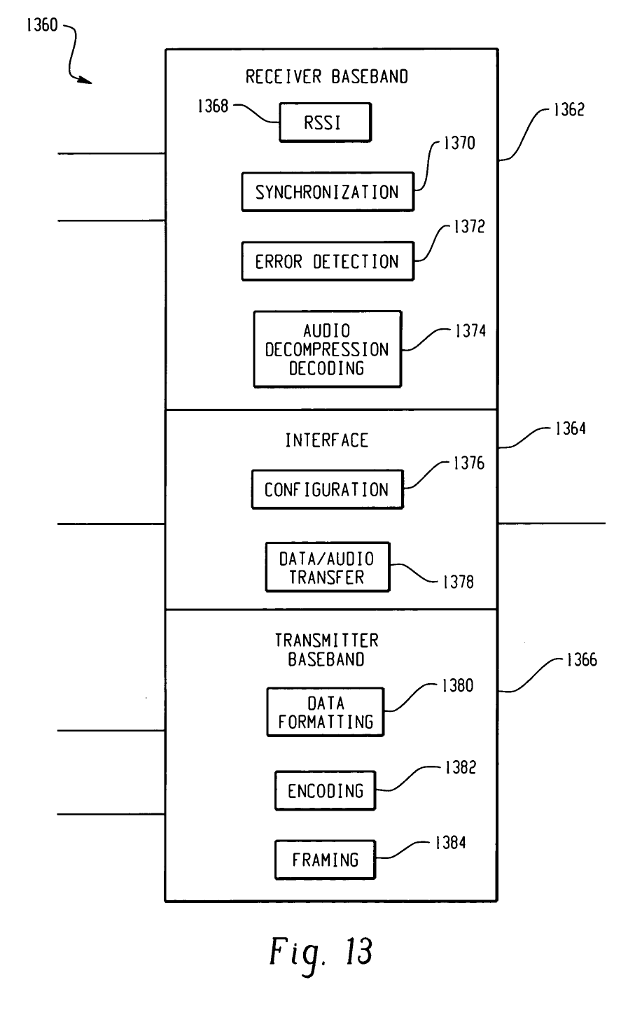

Persons that are particularly hard of hearing can benefit from a binaural hearing instrument system that amplifies and transmits sound into both ears. A system, such as the one described in FIGS. 12 and 13, that is capable of streaming sound received from one hearing instrument to another, allows both of the user's ears to work together to hear a sound, even if the sound is coming primarily from one side. However, when sounds are communicated to both ears at the same time, the user may perceive that the sound is coming from inside their head or from straight ahead. The user loses some directional hearing capability, and this can be disorienting, particularly when the user knows the source of the sound is coming from one side.

It has been discovered that a way to solve this problem is to slightly delay the sound signal that is communicated to the ear that is opposite from where the sound is originating. This short delay mimics how the ears would naturally hear a sound coming from one side of the head. For example, for a sound originating from the left of the user, the sound will first reach the user's left ear, and then slightly later reach the user's right ear. The amount of delay needed to achieve the desired effect will typically be in the range of about 500 uS to about 900 uS. This amount of delay is short enough so that it is not perceived by the user as sounding reverberant or as an echo. By incorporating this time-delay feature in a binaural hearing instrument system that is capable of streaming sound between hearing instruments, the user will benefit from amplified hearing in both ears without suffering the disorienting effect.

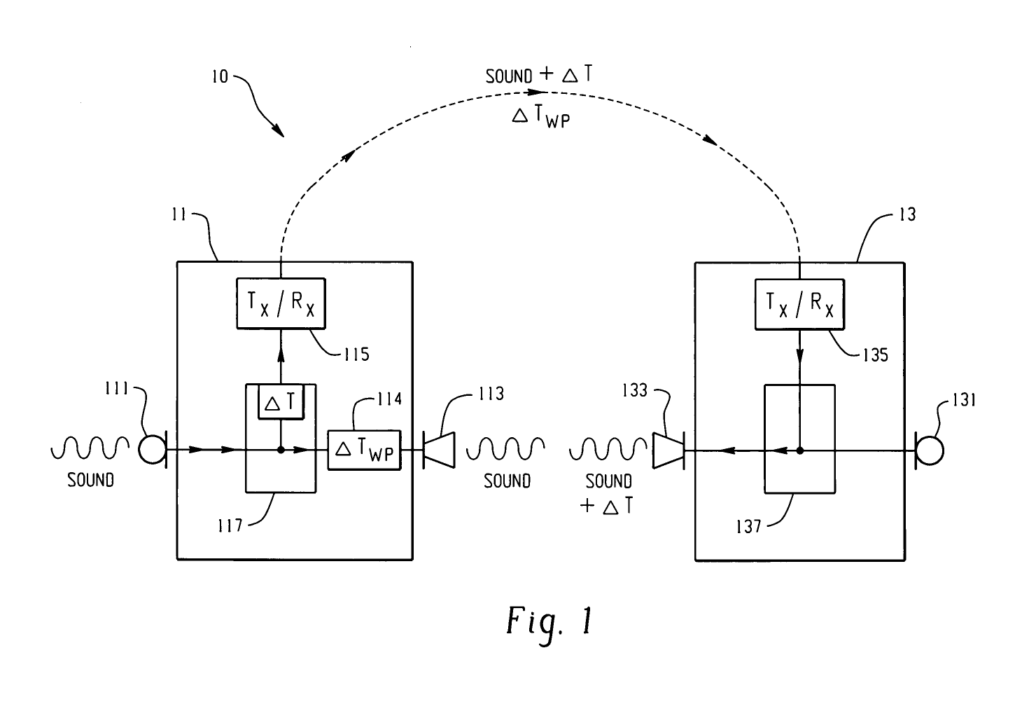

FIG. 1 shows an example time-delay hearing instrument system 10 that includes a first hearing instrument 11 and a second hearing instrument 13. The first hearing instrument 11 includes a first microphone 111, a first speaker 113, and a first communications subsystem 115, and these are each coupled to a first processing circuitry 117. Similarly, the second hearing instrument 13 also includes a second microphone 131, a second speaker 133, and a second communications subsystem 135 that are each coupled to a second processing circuitry 137.

The first and second communications subsystems 115, 135 include an antenna and wireless circuitry that function to transmit sound signals over an air interface. The communications subsystems 115, 135 may include both transmitter and receiver circuitry for bi-directional communication with the other hearing instrument. The communications subsystems 115, 135 may use wireless protocols such as Bluetooth, IEEE 802.11, or WiFi, among others. The communications subsystems 115, 135 may be operable to broadcast at a range of frequencies, and may even reach frequencies at or below 900 MHz, as described in the co-owned previously filed application, titled, “Electrically Small Multi-Level Loop Antenna on Flex for Low Power Wireless Hearing Aid System,” U.S. application Ser. No. 10/986,394. An example communications subsystem is described in greater detail in FIGS. 12 and 13 and the accompanying description.

The first processing circuitry 117, in this example, is operable to apply a time delay (ΔT) to the received signal. In other examples, the second processing circuitry may apply the time delay (ΔT) after the signal is transmitted to the second hearing instrument 13. In another example, both the first and second processing circuitry 117, 137 may apply a time delay (ΔT) to the signal. The first and second processing circuitry 117, 137 may also function to perform other hearing aid functions. For example, the processing circuitry 117, 137 may include an integral processing device, such as a digital signal processor (DSP), for processing received signals. The processing circuitry 117, 137 may perform directional processing functions, sound compression functions, clear channel searching functions, or other signal processing functions. The processing circuitry 117, 137 may perform baseband processing functions on sound signals received from the microphones 111, 113 or other audio inputs (e.g., CD player, television, etc.), such as audio compression, encoding, data formatting, framing, and/or other functions. Also, the processing circuitry 117, 137 may perform baseband processing functions on received data, such as audio decompression and decoding, error detection, synchronization, and/or other functions. In addition to baseband processing functions, the processing circuitry 117, 137 may perform other functions traditionally performed at the hearing instrument, such as directional processing, noise reduction and/or other functions. One possible type of processing circuitry that may be used is Gennum Corporation's part number GC5055. Additionally, the processing circuitry could be the processor disclosed in U.S. patent application Ser. No. 11/100,732, titled “Binaural Hearing Instrument Systems and Methods.” An example of hearing instrument processing and other signal processing functions that may be performed by the hearing instrument module, in addition to the time-delay and binaural processing functions describe herein, is provided in commonly-owned U.S. patent application Ser. No. 10/121,221, entitled “Digital Hearing Aid System,” which is incorporated herein by reference. An example processing circuitry is described in more detail below with reference to FIGS. 12 and 13.

The processing circuitry 117, 137 and communications subsystems 115, 135 may be arranged on one or more printed circuit boards, thin film circuits, thick film circuits, or some other type of circuit that may be sized to fit within a hearing instrument shell. In one additional example, the communications subsystems 115, 135 may be included in an external attachment to the hearing instruments 11, 13. The antenna may be a low-power miniature antenna, such as the antenna described in the commonly-owned U.S. patent application Ser. No. 10/986,394, entitled “Antenna For A Wireless Hearing Aid System,” or U.S. patent application Ser. No. 10/986,394, entitled “Electrically Small Multi-Level Loop Antenna on Flex for Low Power Wireless Hearing Aid System,” both of which are herein incorporated by reference.

In operation, the system shown in FIG. 1 receives a sound signal at the first microphone 111, and the signal is transmitted to the first processing circuitry 117. The first processing circuitry 117 processes the received signal to compensate for a hearing impairment of the ear it is associated with and/or to perform other processing functions. The first processing circuitry 117 also applies a time delay (ΔT) to the received signal and transmits the delayed signal to the first communications subsystem 115, where the signal is wirelessly transmitted over the air to the second example hearing instrument 13. As illustrated, a wireless propagation delay (ΔT_{WP}) is incurred when transmitting the signal (sound+ΔT) over the air medium to the second hearing instrument 13. This is the delay (ΔT_{WP}) associated with the wireless transmission functions, such as compression, framing, transmitting, receiving, decoding, etc. The first hearing instrument 11 thus also applies a wireless propagation delay (ΔT_{WP}) 114 to the processed signal, and the resultant signal is broadcast by the first speaker 113.

After receiving the time-delayed signal (sound+ΔT), the second communications subsystem 135 transmits the signal to the second processing circuitry 137. In most cases, the time-delayed signal will be further processed in the second processing circuitry 137 to compensate for the particular hearing deficiency of the ear it is associated with. After any further processing is completed, the second processing circuitry 137 passes the time-delayed signal to the second speaker 133 for broadcasting. In this manner, the sound signal broadcast by the second speaker 133 is delayed by an amount ΔT with respect to the sound signal broadcast by the first speaker 113.

As explained above, the time delay ΔT causes the hearing instrument user to perceive the sound as coming from the side of the head from which the sound signal is received by the first microphone 111. In addition, broadcasting the signal into both ears provides an additional benefit in that the user perceives a louder apparent sound than if the sound signal were only broadcast into one ear. This phenomenon is known as binaural loudness summation. The magnitude of this apparent loudness growth is typically on the order of 3-7 dB. Moreover, the effect caused by the time delay ΔT has been found to work with amplitude differences of up to 10 dB between ears. That is, the signal transmitted to the opposite ear may be amplified by up to 10 dB and still create the illusion that the sound originated in the other ear. The combination of the binaural loudness summation and additional amplification may thus result in a much loader perceived sound overall than would otherwise be possible in a monaural situation. This may be particularly useful for listening to telephone sounds because microphone pickup of telephone sounds has a tendency for acoustic feedback when the telephone receiver is brought close to the head.

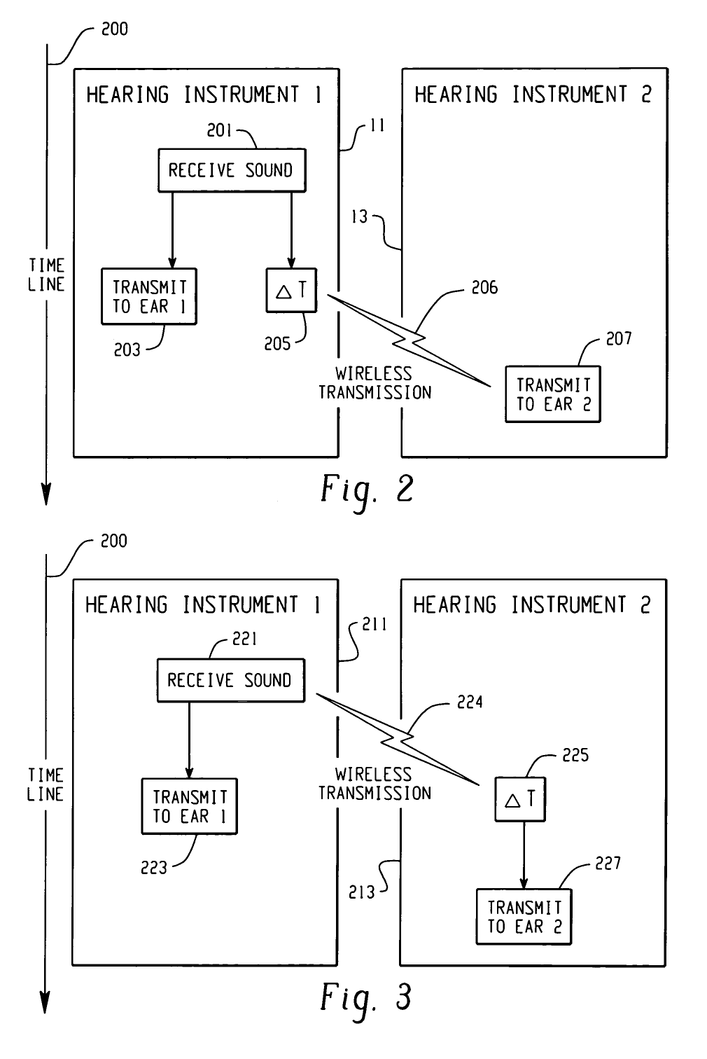

FIG. 2 is an example operational flow-chart that corresponds to the operation of the system 10 in FIG. 1, and follows a time line 200 as it progresses down the page. For simplicity, the wireless propagation delay (ΔT_{WP}) is not shown in FIG. 2 or any of the other remaining Figures. It should be understood, however, that in each example the sound signal may be delayed in the hearing instrument receiving the signal to compensate for the wireless propagation delay (ΔT_{WP}), as described above with reference to FIG. 1.

In the example shown in FIG. 2, the first hearing instrument 11 receives a sound 201, and then broadcasts the signal to a first ear of a user 203 and wirelessly transmits a time-delayed signal 205 to the second hearing instrument 13. The time-delayed signal is then broadcast the user's second ear 207 by the second hearing instrument 13. As a result of the time delay (ΔT) 205, the user will perceive the sound as coming from the direction that their first ear is oriented towards.

FIG. 3 is a second example operational flow-chart that follows a time line 200 as it progresses down the page. The process begins when a first hearing instrument 211 receives a sound 221. Then, the first hearing instrument 211 transmits the sound to a user's first ear 223 and wirelessly transmits 224 the sound as a signal to the second hearing instrument 213. In contrast to the operation shown in FIG. 2, the first hearing instrument 211 does not apply the time delay (ΔT), but, instead, the second hearing instrument applies the time delay (ΔT) 225 after receiving the signal 224. The time-delayed signal is then broadcast to the user's second ear 227, as in the example of FIG. 2, a short time after it is broadcast to the user's first ear, thereby causing the user to perceive the sound as coming from the direction that the first ear is facing. This series of operations could be performed on the hearing instrument system 10 of FIG. 1 with a minor modification to make the second processing circuitry 137 apply the time delay (ΔT).

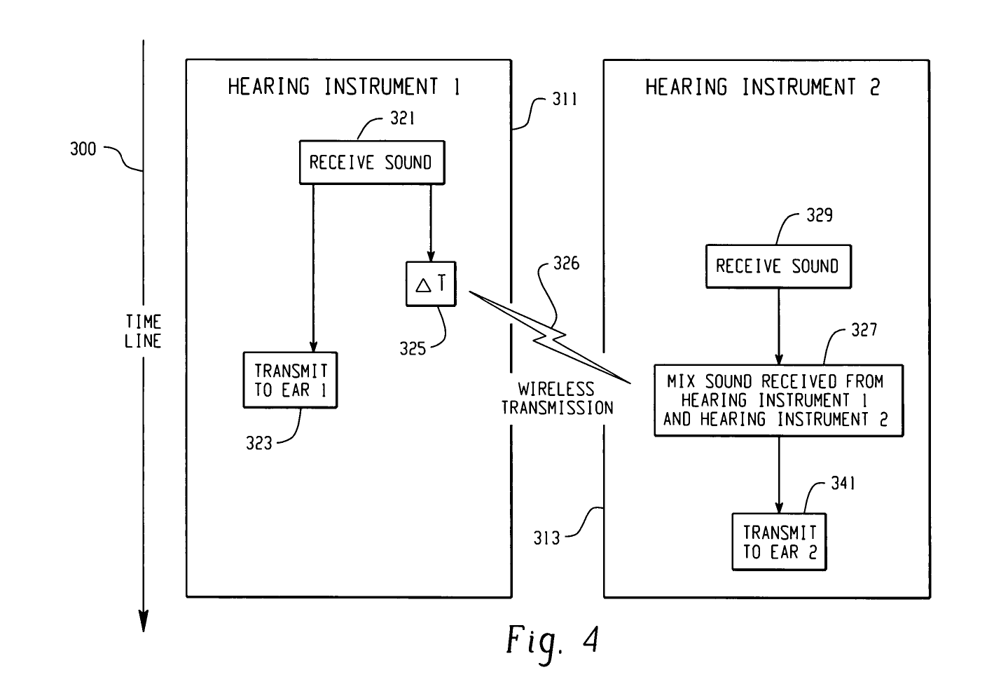

FIG. 4 is a third example operational flow-chart that follows a time line 300 as it progresses down the page. The first hearing instrument 311 receives a sound signal 321 and then broadcasts the signal to a first ear of a user 323. The first hearing instrument 311 also applies a time delay (ΔT) to the sound signal 325, and wirelessly transmits 326 the signal to the second hearing instrument 313. After the time-delayed signal is received, it is mixed 327 with sound concurrently received 329 by the second hearing instrument 313. The mixed sound signal is then transmitted to the user's second ear 341 a short time (ΔT) after the sound received by the first hearing instrument was transmitted to the user's first ear, causing the user to perceive the sound as coming from the direction of the first ear. This example provides the user with a time-delayed signal received from one side of the user, which has the benefits described above, but does not interrupt the real-time binaural sound receiving function of the hearing instrument system. This series of operations could be performed on the hearing instrument system 10 of FIG. 1 with a modification to make the second processing circuitry 137 mix the sounds from the first and second hearing instruments 11, 13.

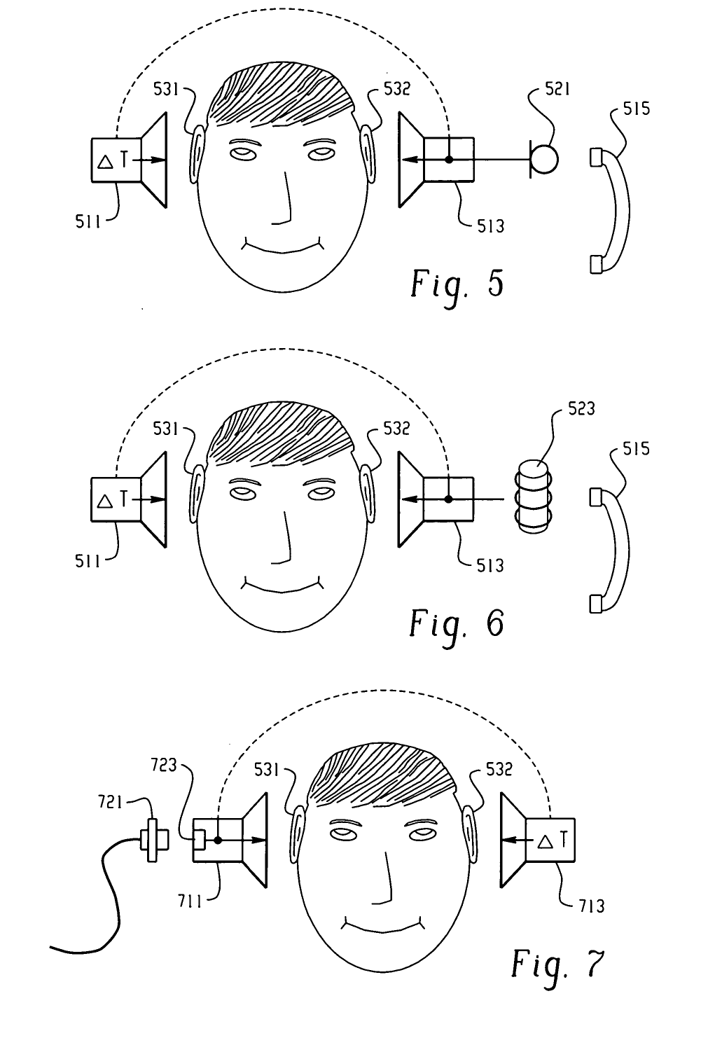

FIGS. 5-8 show some example applications of a time-delay hearing instrument system. FIG. 5 shows a telephone application including first and second hearing instruments 511, 513, and a telephone 515. As sound emanates from the speaker of the telephone 515, a microphone 521 on the second hearing instrument 513 receives the sound and broadcasts it to the user's second ear 532. The signal is also wirelessly transmitted to the first hearing instrument 513. The first hearing instrument applies a short time delay (ΔT) and transmits the time-delayed sound to the user's first ear 531.

The example time-delay hearing instrument system is particularly beneficial in this application, because the user knows the sound is coming from one side. As discussed above, if the sound arrived in the ears at the same time it would be disorienting, because the sound would be perceived to be coming from inside the user's head. The time delay operation allows the user to hear the conversation in both ears, and also provides the proper direction of where the sound is originating from.

One or both of the first and second hearing instruments 511, 513 could also include an input device, such as a button on one of the hearing instruments, to enter the time-delay mode. Moreover, a user could turn the time-delay mode on when they are using the phone, and off when the phone conversation is over by pressing a button on the hearing instrument or by some other means. The user could also choose or switch which ear is to receive the delay, and toggle mixing the sound from both hearing instruments 511, 513 as shown in FIG. 4 by pressing a button.

FIG. 6 shows a variation of the example telephone application of FIG. 5, where the second hearing instrument 513 includes a telecoil 523. The telecoil 523 functions to detect the electromagnetic field vibrations that emanate from a diaphragm in the telephone 515 earpiece. The telecoil 523 can more directly detect the signal coming from the telephone 515 and provides enhanced performance in transmitting sounds from the telephone 515 to a hearing instrument user. The time-delay operation of the first and second hearing instruments 511, 513 is otherwise the same as in FIG. 5.

Just as in the example of FIG. 5, one or more of the first and second hearing instruments 511, 513 could also include an input device to turn the time-delay mode off and on, switch ears, and toggle mixing. The telecoil 523 could also be turned on or off with an input device, such as a button. Since the telecoil 523 is primarily used with a telephone application, it may be beneficial to provide for automatic activation of the time-delay mode, when the telecoil 523 is activated. This would decrease the number of input devices, saving space and costs.

FIG. 7 shows an example input jack application that includes first and second hearing instruments 711, 713, and an input jack 721. The first hearing instrument 711 is provided with a port 723 for receiving the input jack 721. The jack 721 may be connected to any device that provides electronic sound signals. For applications where it is desirable for the user to perceive the sound as coming from one side, the time-delay operation may be engaged by the user with an input device, such as a button. When the time-delay mode is engaged, the signal from the input jack 721 is transmitted from the first hearing instrument 711 as sound to the user's first ear, and a signal will be wirelessly transmitted to the second hearing instrument 713 and time delayed before it is transmitted as sound to the user's second ear 532. Instead of the user having to trigger the time-delay mode, the hearing instrument 711 may be configured to automatically apply the time-delay operation to all input from the input jack 721. Thereby saving space and cost. Examples of audio applications that may benefit from this example include a phone that is connected through the input jack 721 to the hearing instrument 711, and a performance or event that has an input jack 721 available to a hearing instrument user, particularly if the jack is located to one side of where the sound is originating.

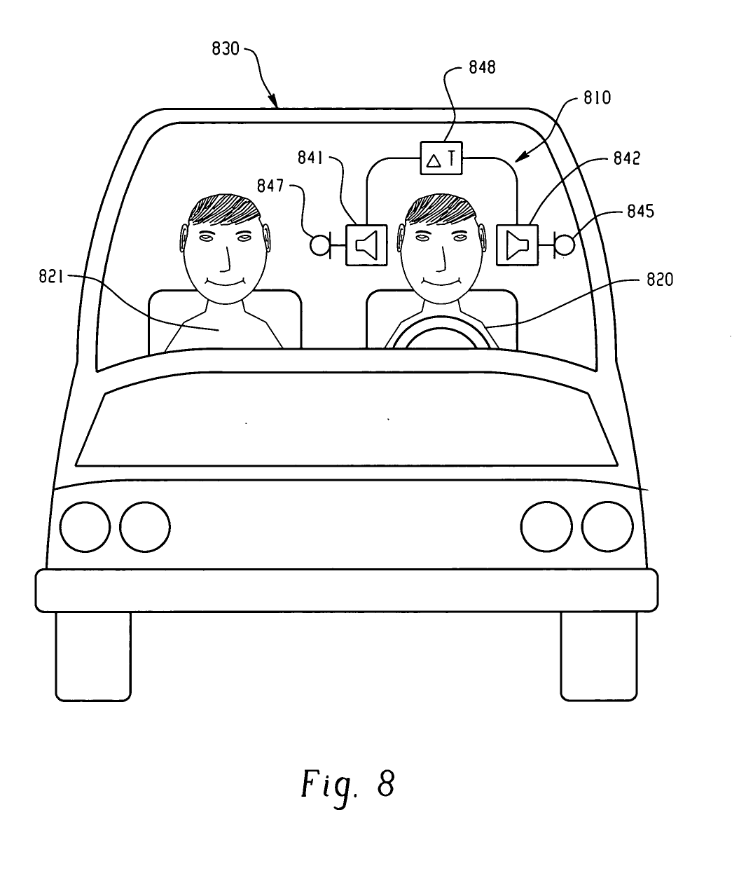

FIG. 8 shows an automobile application for an example time-delay hearing instrument system 810. Automobiles may present a particular problem for hearing instrument users, because the vehicle and road noise, which is amplified along with other noises, can drown out the conversation with other persons in the automobile 830. This may particularly be a problem if the user has better hearing in the ear nearest the exterior of the vehicle. FIG. 8 shows a user 820 seated in the driver's seat of an automobile 830, and a passenger 821 is seated beside the user 820. The user 820 is wearing a time-delay hearing instrument system 810 that includes a first hearing instrument 841 and a second hearing instrument 842, shown here in a diagram format. As sound is received from the first microphone 847 it is transmitted to the user's 820 right ear, and a signal is also transmitted to the second hearing instrument 842. A time delay (ΔT) 848 is applied by either the first or second hearing instrument 841, 842. Then, the time-delayed signal is mixed with the sound received by the second microphone 845 and transmitted to the user's 820 left ear. This allows the user 820 to better hear the conversation in the automobile in both ears, and not be disoriented by hearing the sound in both ears at the same time.

While there may be other solutions to the automobile hearing instrument problem, such as turning off the second hearing instrument 842 or turning off the second microphone 845, each has the drawbacks mentioned in the background section. Furthermore, it would be dangerous to have no hearing amplification of sounds coming from the direction of the driver's side of the vehicle 830, and the disorienting effect may be particularly dangerous while driving. The example time-delay hearing instrument system 810 is a superior solution, because it allows a user 820 to have hearing amplification from both sides, hear conversations in the automobile 830 better in both ears, and also not have the detrimental disorienting effect.

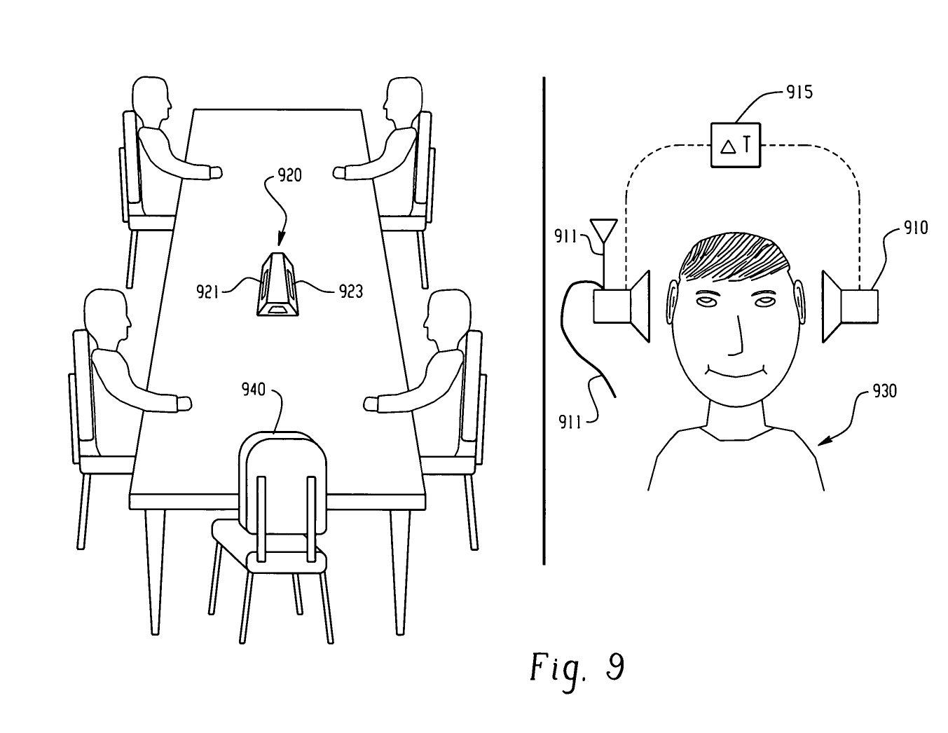

FIG. 9 shows an example time-delay hearing instrument system 910 that is beneficially used in a video or teleconference setting. One difficulty with teleconferencing and video conferencing is that when multiple persons are involved at one connection, it may be difficult for a person at another connection to distinguish between who is talking. An example time-delay binaural hearing instrument system 910 can be used to provide a solution to this problem that is especially useful to those that have hearing deficiencies.

FIG. 9 shows a first connection where a speakerphone 920 is sitting on a table with two persons sitting on each side of the speakerphone 920. The speakerphone 920 has at least two microphones 921, 923 directed to at least a first side and a second side. A user 930 is at a second connection and is listening to the conversation at the first connection through an example time-delay hearing instrument system 910. The example time-delay hearing instrument system 910 is receiving sound from the second connection via a wired or wireless link 911. The link, for example, may go to a telephone or a computer that is accessing the first connection over the internet or through a phone line. The speakerphone 920 is configured to detect from which side the sound is emanating. For example, this can be accomplished by determining whether the microphone directed to the first side 921 or the microphone directed to the second sound 923 is receiving the greatest signal. The speakerphone 920 may then transmit a data signal along with the sound signal transmission to communicate to the time-delay hearing instrument system 910 which side the sound is coming from. The example time-delay hearing instrument system 910 is configured to apply a time delay (ΔT) 915 to the sound transmitted to each ear of the user according to which side of the speakerphone 920 the sound originated from. This enables a user 930 to hear the conversation as though they were seated in the empty chair 940 at the head of the table at the first connection. Moreover, the user is better able to distinguish which person is speaking from the direction they perceive the sound as coming from.

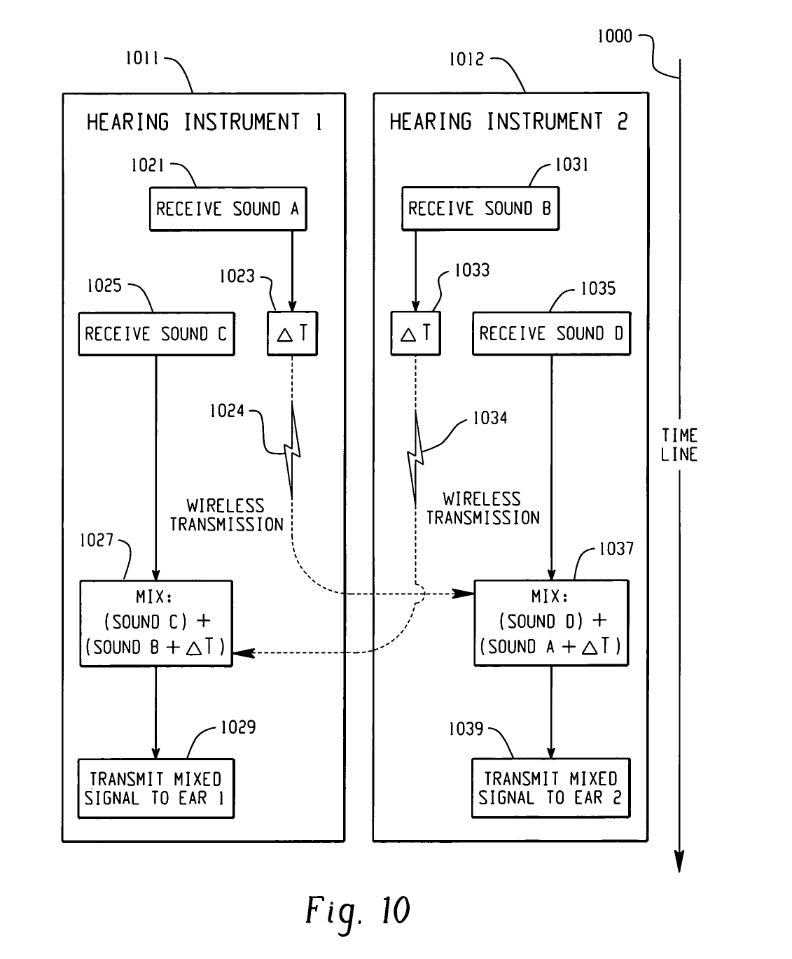

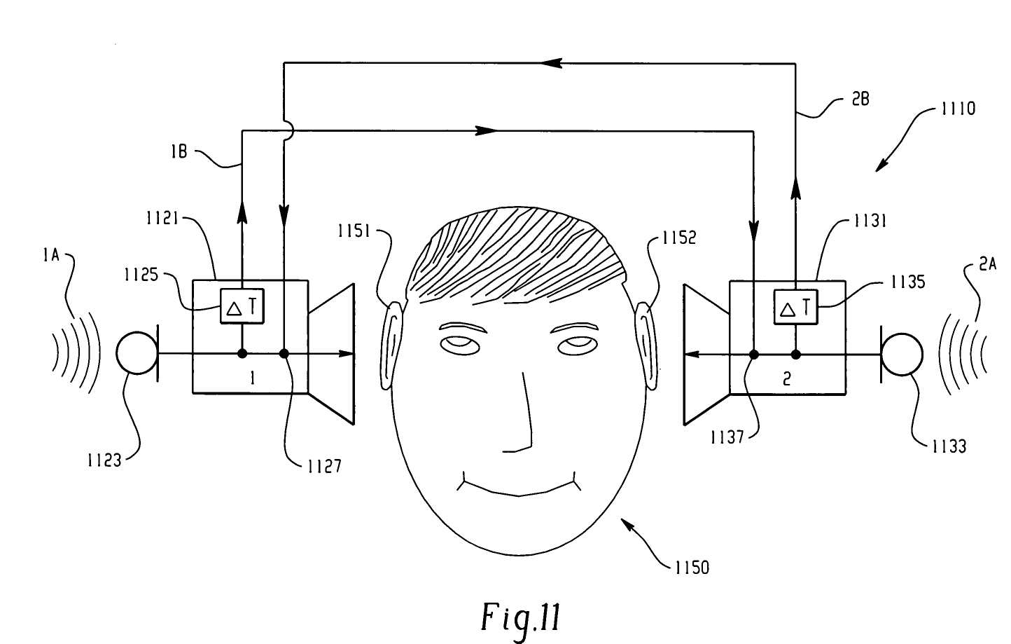

FIG. 10 shows an operational flow chart of a time-delay binaural hearing instrument system that applies a time delay in both a first hearing instrument 1011 and a second hearing instrument 1012. Initially, sound A and sound B are received at the same time 1021, 1031. Then, a short time delay (ΔT) is applied to each signal 1023, 1033. (These sounds A, B may also be transmitted to the speakers on the respective hearing instruments, but this is not shown for the sake of clarity.) After the time delays 1023, 1033, the sound signals A and B are transmitted 1024, 1034, respectively to the second and first hearing instruments 1012, 1011. As the time delays 1023, 1033 are occurring or just after the time delays 1023, 1033 end, sounds C and D are being received 1025, 1035 by the first and second hearing instruments 1011, 1012. At this point, in the first hearing instrument 1011, the currently received sound C and the time-delayed sound A are mixed 1027, and in the second hearing instrument 1012, the currently received sound D and the time-delayed sound B are mixed 1037. Finally, the mixed signals are transmitted to the first and second ears of a user 1029, 1039. In an alternative example, the time delays 1023, 1033 could be applied after the signals A and B are transmitted 1024, 1034, by the opposite hearing instrument.

A similar operation is shown in a diagram of an example time-delay binaural hearing instrument system 1110 in FIG. 11 that has a first and second hearing instrument 1121, 1131. After the sound 1A is received by the first microphone 1123, a time delay (ΔT) is applied 1225 by the processing circuitry. The time-delayed signal 1B is then transmitted wirelessly to the second hearing instrument 1131 by a communications subsystem. The same process occurs in the second hearing instrument 1131 with respect to the sound labeled 2A: the sound 2A is received at the second microphone 1133, then the signal is time delayed 1135, and transmitted to the first hearing instrument 1121. When the time-delayed signal 1B is received in the second hearing instrument 1131 it is mixed 1137 with an undelayed currently received signal and transmitted to the user's second ear 1152 as a mixed signal. When the time-delayed signal 2B is received in the first hearing instrument 1121 it is mixed 1127 with an undelayed currently received signal and transmitted to the user's first ear 1151 as a mixed signal.

The example operations of the example time-delay binaural hearing instrument systems of FIGS. 10 and 11 may be activated by an input device located on one or both of the hearing instruments. These examples may be used in the video and teleconferencing application of FIG. 9. These examples may also enhance the user's ability to perceive which direction a sound is coming from in other applications.

Although the steps in the described examples above are illustrated and described as discrete events, in reality the steps may be occurring in a continuum, where the sound is continually being received and transmitted.

FIG. 12 is a block diagram of an example hearing instrument 1200 showing a more-detailed example of the processing and communications circuitry. The example hearing instrument 1200 includes an RF communication module 1212, a hearing instrument processor 1214, an antenna 1216, one or more hearing instrument microphones 1218, a hearing instrument speaker 1220, and one or more external components 1222 (e.g., resistive and reactive circuit components, filters, oscillators, etc.) As illustrated, the RF communication module 1212 and the hearing instrument processor 1214 may each be implemented on a single integrated circuit, but in other examples could include multiple integrated circuits and/or external circuit components.

The RF communication module 1212 includes a baseband processor 1240 and communications circuitry. The communications circuitry includes a transmit path and a receive path. The receive path includes a low noise amplifier (LNA) 1224, a down conversion quadrature mixer 1226, 1228, buffering amplifiers 1226, 1228, an I-Q image reject filter 1234 and a slicer 1236, 1238. The transmit path includes a modulator 1241, an up conversion quadrature mixer 1242, 1244 and a power amplifier 1246. The receive and transmit paths are supported and controlled by the baseband processor 1240 and clock synthesis circuitry 1248, 1250, 1252. The clock synthesis circuitry includes an oscillator 1248, a phase locked loop circuit 1250 and a controller 1252. The oscillator 1248 may, for example, use an off chip high Q resonator (e.g., crystal or equivalent) 1222. The frequency of the phase locked loop circuit 1250 is set by the controller 1252, and controls the operating frequency channel and frequency band. The controller 1252 may, for example, select the operating frequency channel and/or frequency band of the system. Also included in the RF communication module 1212 are support blocks 1254, which may include voltage and current references, trimming components, bias generators and/or other circuit components for supporting the operation of the transceiver circuitry.

In operation, an RF signal received by the antenna 1216 is amplified by the LNA 1224, which feeds the down conversion mixer 1226, 1228 to translate the desired RF band to a complex signal. The output of the down conversion mixer 1226, 1228 is then buffered 1230, 1232, filtered by the image reject filter 1234 and slicer 1236, 1238 and input to the baseband processor 1240. The baseband processor 1240 performs baseband processing functions, such as synchronizing the incoming data stream, extracting the main payload and any auxiliary data channels (RSSI and AFC information), and performing necessary error detection and correction on the data blocks. In addition, the baseband processor 1240 decompresses/decodes the received data blocks to extract the sound signal.

Outgoing sound and/or control signals may be encoded and formatted for RF transmission by the baseband processor 1240. In the case of outgoing sound signals, the baseband processor 1240 may also perform sound compression functions. The processed signal is modulated to an RF carrier by the modulator 1241 and up conversion mixer 1242, 1244. The RF signal is then amplified by the power amplifier 1246 and transmitted over the air medium by the antenna 1216.

The hearing instrument processor 1214 functions to time delay signals received from the one or more microphones 218, and may perform traditional hearing instrument processing functions to compensate for the hearing impairments of a hearing instrument user, along with the binaural processing functions described herein. The hearing instrument processor 1214 may also perform other signal processing functions, such as directional processing, occlusion cancellation, or other functions.

FIG. 13 is a functional diagram of an example baseband processor 1360 for a hearing instrument. The baseband processor 1360 may perform receiver baseband processing functions 1362, interface functions 1364 and transmitter baseband processing functions 1366. The illustrated baseband processor 1360 includes two receiver inputs, two interface input/outputs, and two transmitter outputs, corresponding to the input/outputs to the baseband processor 1240 shown in FIG. 12. It should be understood, however, that other input/output configurations could be used.

The receiver baseband processing functions 1362 include signal level baseband functions 1368, 1370, such as a synchronization function 1370 to synchronize with the incoming data stream, and a data extraction function 1368 for extracting the payload data. Also included in the receiver functions 1362 are an error detection function 1372 for detecting and correcting errors in the received data blocks, and a sound decompression decoding function 1374 for extracting a sound signal from the received data blocks.

The transmitter baseband processing functions 1366 include data formatting 1380 and framing 1384 functions for converting outgoing data into an RF communication protocol and an encoding function 1382 for error correction and data protection. The RF communication protocol may be selected to support the transmission of high quality audio data as well as general control data, and may support a variable data rate with automatic recognition by the receiver. The encoding function 1382 may be configurable to adjust the amount of protection based on the content of the data. For example, portions of the data payload that are more critical to the audio band from 100 Hz to 8 kHz may be protected more than data representing audio from 8 kHz to 16 kHz. In this manner, high quality audio, although in a narrower band, may still be recovered in a noisy environment. In addition, the transmitter baseband processing functions 1366 may include an audio compression function for compressing outgoing audio data for bandwidth efficient transmission.

The interface functions 1364 include a configuration function 1376 and a data/sound transfer function 1378. The data/sound transfer function 1378 may be used to transfer data between the baseband processor 1360 and other circuit components (e.g., a hearing instrument processor) or external devices (e.g., computer, CD player, etc.) The configuration function 1376 may be used to control the operation of the communications circuitry. For example, the configuration function 1376 may communication with a controller 1352 in the communications circuitry to select the operating frequency channel and/or frequency band.

This written description uses examples to disclose the invention, including the best mode, and also to enable a person skilled in the art to make and use the invention. The patentable scope of the invention may include other examples that occur to those skilled in the art. For example, the time delay and communications subsystem described herein may instead be incorporated in devices other than a hearing instrument, such as a wired or wireless headset, a pair of communication ear-buds, a body worn control device, or other communication devices that are capable of communicating separately to two ears.

It is claimed:

1. A binaural hearing instrument system, comprising:
a first hearing instrument configured to transmit sound signals into a first ear of a hearing instrument user;
a second hearing instrument configured to transmit sound signals into a second ear of the hearing instrument user;
the first and second hearing instruments including wireless communications circuitry configured to transmit signals, including sound signals, over an air interface between the first and second hearing instruments;
binaural processing circuitry configured to apply a time delay to a sound signal received by the first hearing instrument to generate a delayed sound signal;
the first hearing instrument being configured to transmit the received sound signal into the first ear of the hearing instrument user;
the second hearing instrument being configured to transmit the delayed sound signal into the second ear of the hearing instrument user.

2. The binaural hearing instrument system of claim 1, wherein the time delay is in a range of about 300 uS to about 900 uS.

3. The binaural hearing instrument system of claim 1, wherein the received sound signal emanates from a telephone.

4. The binaural hearing instrument system of claim 1, further comprising a telephone coil that is operable to receive a signal from a telephone,
wherein the processing circuitry is further operable to apply the time delay to a signal received from the telephone coil.

5. The binaural hearing instrument system of claim 1, wherein the first hearing instrument transmits the received sound signal wirelessly.

6. The binaural hearing instrument system of claim 1, wherein both the first and second hearing instruments include the binaural processing circuitry configured to apply the time delay.

7. The binaural hearing instrument system of claim 1, wherein only the first hearing instrument includes the binaural processing circuitry configured to apply the time delay.

8. A binaural hearing instrument system comprising:
a first hearing instrument;
a second hearing instrument;
the first hearing instrument and second hearing instrument being operable to communicate with each other;
the first hearing instrument being operable to receive a first signal, transmit the first signal to the second hearing instrument, and transmit the first signal to a first speaker;
the second hearing instrument being operable to receive the first signal and transmit the signal to a second speaker;
the first speaker transmitting the first signal before the second speaker transmits the first signal.

9. The binaural hearing instrument system of claim 8, wherein the first and second hearing instruments are operable to communicate with each other wirelessly.

10. The binaural hearing instrument system of claim 8, wherein the first hearing instrument applies a time delay to the first signal.

11. The binaural hearing instrument system of claim 8, wherein the second hearing instrument applies a time delay to the first signal.

12. The binaural hearing instrument system of claim 10, wherein the second hearing instrument receives the first signal from the first hearing instrument, receives a second signal, mixes the first and second signals to create a mixed signal, and transmits the mixed signal through the second speaker after the first signal has been transmitted through the first speaker.

13. The binaural hearing instrument system of claim 12, wherein the second signal is received approximately 500 uS to 900 uS after the signal was received.

14. The binaural hearing instrument system of claim 8, wherein the first speaker transmits the signal approximately 500 uS to 900 uS before the second signal.

15. The binaural hearing instrument system of claim 8, wherein the first hearing instrument receives a first signal and at the same time the second hearing instrument receives a second signal;
the first hearing instrument transmits the first signal to the second hearing instrument, and the second hearing instrument transmits the second signal to the first hearing instrument;
the first and second signals are time delayed;
the first hearing instrument mixes the delayed second signal with currently received sound to create a first mixed signal, and transmits the first mixed signal through the first speaker;
the second hearing instrument mixes the delayed first signal with currently received sound to create a second mixed signal, and transmits the second mixed signal through the second speaker.

16. A method for enhancing the hearing of sounds, the steps of which comprise:
receiving a signal;
transmitting the signal as a sound wave to a first ear;
applying a time delay to the signal;
transmitting the delayed signal as a sound wave to a second ear.

17. The method of claim 16, wherein the signal emanates from a telephone.

18. The method of claim 16, wherein the signal is received by a telecoil.

19. A hearing instrument system comprising:
means for receiving a signal;
means for transmitting the signal as a sound wave to a first ear;
means for applying a time delay to the signal; and
means for transmitting the delayed signal as a sound wave to a second ear.

20. The hearing instrument system of claim 19, wherein the means for receiving the signal is a telecoil.

21. The hearing instrument system of claim 19, further comprising wireless means for transmitting the signal from a first hearing instrument to a second hearing instrument.

22. A method for enhancing communication, the steps of which comprise:
receiving sound from at least a first and second direction;
communicating the sound to a binaural hearing instrument system;
transmitting sound from the first direction to a first ear; and
transmitting sound from the first direction to a second ear after the sound is transmitted to the first ear.

23. The method of claim 22, further comprising the steps of:
transmitting sound from the second direction to a second ear; and
transmitting sound from the second direction to a first ear after the sound is transmitted to the second ear.

24. The method of claim 22, wherein the binaural hearing instrument system includes a first and second hearing instrument, and the first hearing instrument transmits sound from the first direction to the first ear, and wirelessly transmits sound to the second hearing instrument to be transmitted to a second ear after the sound is transmitted to the first ear.

25. The method of claim 22, wherein the binaural hearing instrument system applies a time delay to the sound transmitted to the second ear.
